(19) United States
(12) Patent Application Publication
(10) Pub. No.: US 2008/0236960 A1
(43) Pub. Date: Oct. 2, 2008

(54) Disc Brake for a Utility Vehicle

(75) Inventors: Robert THEIL, Kottgeisering (DE); Tobias Linke, Bad Vilbel (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge GmbH, Muenchen (DE)

(21) Appl. No.: 12/044,542

(22) Filed: Mar. 7, 2008

Related U.S. Application Data
(63) Continuation of application No. PCT/EP2006/008672, filed on Sep. 6, 2006.

(30) Foreign Application Priority Data
Sep. 8, 2005 (DE) 10 2005 042 796.0

(51) Int. Cl. F16D 55/22

(52) U.S. Cl. 188/73.31

(57) ABSTRACT

A disc brake for a utility vehicle includes a caliper which straddles the brake disc, in addition to functional parts which are arranged outside of the caliper, as drive parts of an adjusting device, which are encapsulated by a cover fixed to the outside of the caliper. The disc brake is configured in such a way that the cover is connected in a material integral manner to the caliper.

### CROSS-REFERENCE TO RELATED APPLICATIONS

This application is a continuation of PCT International Application No. PCT/EP2006/008672, filed on Sep. 6, 2006, which claims priority under 35 U.S.C. §119 to German Application No. 10 2005 042 796.0, filed Sep. 8, 2005, the entire disclosures of which are expressly incorporated by reference herein.

### BACKGROUND AND SUMMARY OF THE INVENTION

The present invention relates to a disc brake for a utility or commercial vehicle having a caliper that straddles a brake disc. Functional parts, such as drive parts, of a wear adjustment device, are arranged, in particular, outside the caliper and are encapsulated by a cover fastened exteriorly to the caliper.

A disc brake of this type is known, for example, from DE 103 00 013 A1.

For the functioning of such a disc brake, inter alia, an adjusting device is provided, by which an amount of lifting play between the brake disc and brake pad can be set. The adjustment device is operated, for example, via a synchronous transmission and, for this purpose, has an output gearwheel, which can be driven mechanically or via an electric motor. Both the output gearwheel and electric motor may be arranged inside or outside the caliper, as are further functional parts which are required for operating the disc brake.

For protection against mechanical and climatic or environmental influences, these functional parts are covered by a cover, and to that extent are encapsulated with respect to the surroundings. The cover is connected to the caliper.

This connection has hitherto taken place positively, in particular by screwing, but has the disadvantage that this connection can be released in any event. This type of connection, however, does not provide reliable protection against manipulation, and there is, therefore, the risk that there may be improper or unauthorized access to the functional parts encapsulated by the cover.

Particularly, in the case of repair work which may become necessary, this may present problems which constitute a potential risk to the operating reliability of the disc brake.

Furthermore, the mounting of the cover and, in particular, the preparation of the connection points, is complicated and therefore costly, since threaded bores must be provided in the caliper, which, of course, can be implemented only at considerable outlay in terms of manufacturing costs.

Since such disc brakes are produced as standard parts in large quantities, there is considerable importance in having efficient manufacture, with regard to which the known disc brakes are only an inadequate solution.

The object on which the invention is based, therefore, is to develop further a disc brake of the above-described type such that the cover for encapsulating functional parts is fastened in a manipulation-proof manner. A more cost-effective production and assembly of the cover and disc brake are also possible.

This object is achieved by a disc brake having a caliper that straddles a brake disc. Functional parts, such as drive parts, of a wear adjustment device, are arranged, in particular, outside the caliper and are encapsulated by a cover fastened exteriorly to the caliper. The cover is connected to the brake caliper in a materially integral manner.

A disc brake designed according to the invention affords considerable advantages, as compared with the prior art.

First, on the one hand, the manipulation-proof fastening of the cover must be mentioned, since the materially integral connection, preferably by welding, is possible only as a result of the mechanical destruction of the connection points.

Furthermore, the machining of the caliper for fastening the cover may largely be dispensed with, since connection junctions, such as threaded bores or the like, are no longer required.

Dispensing with preparatory work in this way leads, for obvious reasons, to a reduction in the manufacturing costs, thus resulting in appreciable savings.

Dispensing with connection mechanisms, such as the screws mentioned previously, also leads to a reduction in costs, to which a shorter manufacturing time likewise contributes, since the materially integral connection can be made more quickly than a positive connection.

Owing to the materially integral connection, which, as mentioned, is preferably made by welding, but, in principle, may also take place by adhesive bonding, a transmission of axial and transverse forces is possible, while an improvement in the contact pattern can be achieved by any desired choice of the number of contact points.

Welding may be carried out by way of a laser or welding electrodes. In laser welding, in the bearing region of the cover with respect to the caliper, a plurality of perforations, preferably in the form of bores, are provided, at the inner margin of which a peripheral laser weld seam is generated, by which the welded joint is made.

In welding by way of a welding electrode, the cover bears with a pronounced welding lug or tenon against the brake caliper, while the welding electrode is introduced into a concentric blind hole, which the welding lug adjoins. Welding in this case takes place inductively. It is also contemplated for the caliper to be provided with welding lugs.

In the case of a metal cover, the welding lugs may be introduced by embossing, whereas, in the case of a plastic cover, the respective welding lug is an integral part of a metal ring used which, secured at least axially, is seated in the plastic cover. Metal rings introduced into the plastic cover also serve for connection by way of laser welding, in which case the metal ring is modified correspondingly.

Both welding methods may be automated, that is to say automatic welding of the cover to the caliper can be carried out very efficiently by use of a suitable robot.

Other objects, advantages and novel features of the present invention will become apparent from the following detailed description when considered in conjunction with the accompanying drawings.

### BRIEF DESCRIPTION OF THE DRAWINGS

FIG. 1 shows a cover of a disc brake according to the invention in a perspective view;

FIGS. 2 and 3 show in, each case, exemplary embodiments of a detail of the cover according to FIG. 1; and

FIGS. 4 to 6 shows partial cross sections through a detail of the cover connectable to a caliper.

### DETAILED DESCRIPTION OF THE DRAWINGS

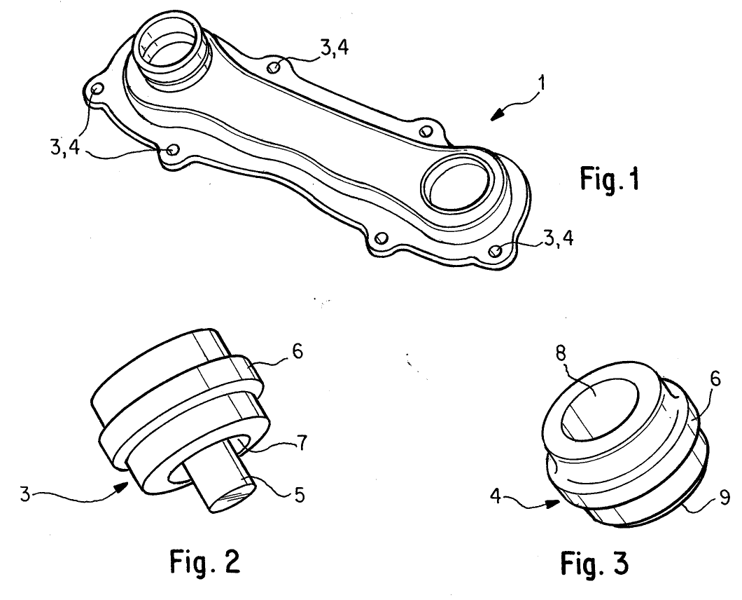

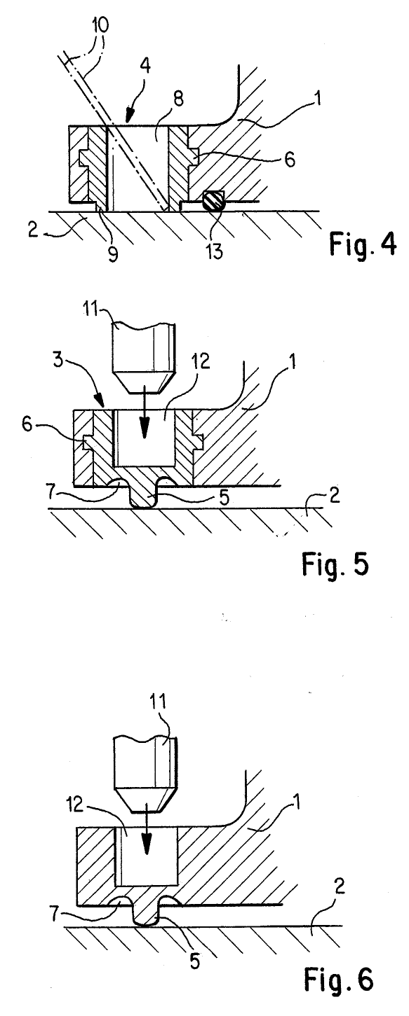

FIG. 1 illustrates a cover 1, which is connectible in a material integral manner to an indicated caliper 2 (FIG. 4) of a disc brake for a utility or commercial vehicle. The cover 1 covers, via an encapsulating effect, functional parts (not illustrated) that are arranged on an exterior (or outside) of the brake caliper 2. The functional parts are typically those of an adjustment device, such as its drive parts.

The cover 1 shown in FIG. 1 is produced from plastic and, in a marginal region of its outer contour, has several inserted metal rings 3 or 4, an exemplary embodiment of which is, in each case, illustrated in enlarged form in FIGS. 2 and 3.

The metal rings 3, 4 are mounted so as to be secured axially, and preferably also secured rotationally or against twisting, in the cover 1. For this purpose, a circumferential bead 6 is integrally formed on the metal ring 3, which bead 6 matches positively with the cover 1.

The metal ring 3 is configured such that it can be welded to the brake caliper 2 by way of an electrode 11 (FIG. 5). In this case, the metal ring 3 has, on its end facing the brake caliper 2, a central lug or tenon 5, which melts when the electrode 11 is introduced into a blind hole 12 of the metal ring 3 and current is applied, and is at the same time welded to the brake caliper 2, which likewise consists of metal. Excess welding material of the lug 5 is received into a concentric undercut, which is formed adjacent to the lug 5.

In the example shown in FIG. 6, the cover 1 consists of metal. The lug 5, here, is shaped by the corresponding embossing of the cover 1, so as to form the blind hole 12.

So that induction welding with low current intensity can be carried out, the cross section of the lug 5 is kept relatively small, while the selected outside diameter of the metal ring 3 designed as a rotationally symmetrical body is relatively large, so that the metal ring heats up only slightly during welding.

FIGS. 3 and 4 show a further exemplary embodiment of a metal ring 4 in the plastic cover 1, which, like that shown in FIGS. 2 and 5, is mounted in an axially secured manner.

This metal ring 4 is provided with a throughbore 8 and on its end face facing the brake caliper 2 has a bearing ring 9 with which it is supported on the caliper 2.

The metal ring 4 is welded to the brake caliper 2 by laser welding, a laser beam 10 being illustrated diagrammatically in FIG. 4 for clarity.

In this case, welding takes place on the lower inner circumference of a throughbore 8, which forms a transition to the caliper 2 and by melting makes it possible to have a fixed connection of the metal ring 4 and, consequently, of the cover 1 to the caliper 2.

There is, of course, also the possibility of connecting the metal cover 1 to the brake caliper 2 in a materially integral manner by way of laser welding, in which case the cover 1 has bearing rings 9 integrally formed correspondingly.

Since the welding of the cover 1 to the caliper 2 takes place, as it were, in a punctiform manner, a seal 13 is provided peripherally for sealing off the inner space, which receives the functional parts, of the cover 1 with respect to the surroundings. The seal 13 is supported sealingly, on the one hand, on the cover 1 and, on the other hand, on the caliper 2.

### TABLE OF REFERENCE SYMBOLS

1 Cover
2 Brake caliper
3 Metal ring
4 Metal ring
5 Tenon
6 Bead
7 Undercut
8 Bore
9 Bearing ring
10 Laser beam
11 Electrode
12 Blind hole
13 Seal

The foregoing disclosure has been set forth merely to illustrate one or more embodiments of the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A disc brake for a commercial vehicle, comprising:
a caliper that straddles a brake disc when in use;
functional parts of the disc brake, the functional parts being arranged outside of the caliper; and
a cover encapsulating the functional parts, the cover being connected exteriorly to the caliper in a materially integral manner.

2. The disc brake according to claim 1, wherein the materially integral manner is in the form of a weld connecting the cover to the caliper.

3. The disc brake according to claim 1, wherein the materially integral manner is in the form of an adhesive bond connecting the cover to the caliper.

4. The disc brake according to claim 2, wherein the weld is a laser weld connecting the cover to the caliper.

5. The disc brake according to claim 2, wherein the weld is an induction weld connecting the cover to the caliper.

6. The disc brake according to claim 5, further comprising:
a plurality of lugs arranged on one of the cover on a side facing the caliper and a caliper on a side facing the cover; and
said plurality of lugs being induction welded via an electrode to connect the cover to the caliper.

7. The disc brake according to claim 6, wherein a concentric undercut is operatively arranged adjacent each of the plurality of lugs, the concentric undercut receiving excess welding material of the lugs during the induction welding.

8. The disc brake according to claim 6, wherein a blind hole is arranged concentrically with respect to an axis of each lug, said blind hole being operatively configured to receive the electrode for use during the induction welding.

9. The disc brake according to claim 7, wherein a blind hole is arranged concentrically with respect to an axis of each lug, said blind hole being operatively configured to receive the electrode for use during the induction welding.

10. The disc brake according to claim 4, wherein the cover includes concentric bearing rings arranged on a side facing the caliper, said concentric bearing rings being welded to the caliper via the laser welding.

11. The disc brake according to claim 10, wherein each concentric bearing ring delimits a throughbore, an inner marginal region of the throughbore that faces the caliper being laser welded to the caliper via laser beams.

12. The disc brake according to claim 1, wherein the cover is substantially formed of a plastic material, the disc brake further comprising:
a plurality of metal rings mounted in an axially secured manner in the cover; and
one of a lug and a bearing ring being integrally formed into each metal ring.

13. The disc brake according to claim 12, wherein said lug or bearing ring of each metal ring is induction welded via an electrode to connect the cover to the caliper.

14. The disc brake according to claim 13, wherein a concentric undercut is operatively arranged in the metal ring adjacent the lug, the concentric undercut receiving excess welding material of the lug during the induction welding.

15. The disc brake according to claim 14, wherein a blind hole is arranged in the metal ring concentrically with respect to an axis of the lug, said blind hole being operatively configured to receive an electrode for use during the induction welding.

16. The disc brake according to claim 12, wherein the concentric bearing ring delimits a throughbore, an inner marginal region of the throughbore that faces the caliper being laser welded to the caliper via laser beams.

17. The disc brake according to claim 12, wherein each metal ring comprises a peripheral bead which positively engages with a portion of the cover in which the metal ring is mounted in an axially secured manner.
